(19) United States
(12) Patent Application Publication
(10) Pub. No.: US 2018/0363765 A1
(43) Pub. Date: Dec. 20, 2018

(54) TRANSMISSION CONTROL DEVICE DETECTING CHANGE OF SHIFT LEVEL AND VEHICLE HAVING THE SAME

(71) Applicant: KYUNG CHANG INDUSTRIAL CO., Ltd., Daegu (KR)

(72) Inventor: Hyeong Seok HONG, Daegu (KR)

(21) Appl. No.: 15/906,385

(22) Filed: Feb. 27, 2018

(30) Foreign Application Priority Data
Jun. 20, 2017 (KR) 10-2017-0078114

(51) Int. Cl. F16H 59/04; G01D 5/14

(52) U.S. Cl. CPC F16H 59/044; F16H 2059/0269; G01D 5/145

(57) ABSTRACT

A transmission control device may be provided that includes: a magnet; a magnetic sensor which measures a magnetic field which is changed according to a relative position with respect to the magnet; a housing in which the magnetic sensor is disposed; a shift lever which includes a lever body and a knob which is disposed on one end of the lever body and receives a shift level from a user; and a linkage which, together with the lever body, forms a first joint structure on one end and which, together with the housing, forms a second joint structure on the other end on which the magnet is disposed.

### BACKGROUND

### Field

The present disclosure relates to a transmission control device and more particularly to a transmission control device of a manual transmission, which detects the change of the shift level and a vehicle including the same.

### Description of the Related Art

A transmission converts the power generated by an engine into a rotational force. In an internal combustion engine, a Revolution Per Minute (RPM) band for obtaining the maximum torque is different from a Revolution Per Minute (RPM) band for obtaining the maximum output. Therefore, it is necessary to select an appropriate shift position according to a vehicle speed or an engine RPM and to convert the power into a rotational force.

Here, a transmission control device controls a transmission. The shift control device is divided into a manual shift control device (a manual transmission) and an automatic shift control device (an automatic transmission). The manual shift control device changes manually the shift position by user's operations. The automatic shift control device changes automatically the shift position.

Meanwhile, when a vehicle is started but is not traveling, it is called an idling state. Since the engine is clearly running even in this idling state, fuel is consumed, so that the fuel efficiency is reduced and air pollution is caused. Therefore, to solve these problems, research is being devoted to an Idle Stop & Go (ISG) function in which the engine is turned off by detecting the idling state. Also, a vehicle equipped with this function is being manufactured.

Regarding the manual transmission control device, in a conventional device which implements the Idle Stop & Go (ISG) function, a sensor detecting the state where a vehicle is not traveling has a large and complex structure. Therefore, it is difficult to install the sensor in a narrow space.

For example, Korean Patent Application Laid-Open Publication No. 10-2014-0075175 (Jun. 19, 2014) describes the Idle Stop & Go (ISG) function, but does not specifically disclose the sensor detecting the state where a vehicle is not traveling. Therefore, a transmission control device that can be installed in a narrow space still cannot be proposed.

### SUMMARY

One embodiment is a transmission control device including: a magnet; a magnetic sensor which measures a magnetic field which is changed according to a relative position with respect to the magnet; a housing in which the magnetic sensor is disposed; a shift lever which includes a lever body and a knob which is disposed on one end of the lever body and receives a shift level from a user; and a linkage which, together with the lever body, forms a first joint structure on one end and which, together with the housing, forms a second joint structure on the other end on which the magnet is disposed.

A center of rotation of the first joint structure may move in space, and a center of rotation of the second joint structure may be fixed at a predetermined position.

The first joint structure may be a hinge joint structure.

A first rotor may be formed on one end of the linkage, and the lever body may have a first fixing hole surrounding the first rotor.

The lever body may include a spherical lever ball in which the first fixing hole is formed, and the shift lever may rotate about the center of the lever ball as a center of rotation.

When the shift lever rotates about a first rotational axis in a first direction, the linkage may rotate about a second rotational axis parallel to the first rotational axis in a second direction reverse to the first direction.

When the shift lever rotates in a third direction about a third rotational axis that is orthogonal to the first rotational axis, the linkage may rotate about the third rotational axis in the third direction.

The second joint structure may be a ball-socket joint structure.

A second rotor may be formed on the other end of the linkage. The housing may have a second fixing hole surrounding the second rotor. The magnetic sensor may be a Hall integrated circuit (Hall IC).

Another embodiment is a vehicle including: an engine which generates power; a transmission which use different gears according to a shift level and converts the power into a rotational force; and a transmission control device which controls the shift level. The transmission control device includes: a magnet; a magnetic sensor which measures a magnetic field which is changed according to a relative position with respect to the magnet; a housing in which the magnetic sensor is disposed; a shift lever which includes a lever body and a knob which is disposed on one end of the lever body and receives the shift level from a user; and a linkage which, together with the lever body, forms a first joint structure on one end and which, together with the housing, forms a second joint structure on the other end on which the magnet is disposed.

The vehicle may further include an electronic control unit (ECU) which drives an idle stop & go (ISG) function on the basis of the magnetic field measured at a neutral level where the power of the engine is not transmitted to wheels.

### BRIEF DESCRIPTION OF THE DRAWINGS

FIG. 1 is a block diagram showing a transmission control device according to embodiments of the present invention;

FIG. 2 is a perspective view showing an example of the transmission control device of FIG. 1;

FIG. 3 is a cross sectional view taken along line A-A′ of the transmission control device of FIG. 2;

FIG. 4 is a perspective view showing examples of a first to a third rotational axes about which a shift lever and a linkage which are included in the transmission control device of FIG. 2 rotate;

FIG. 5 is a perspective view showing an example in which the shift lever and the linkage included in the transmission control device of FIG. 2 rotate about the first rotational axis and the second rotational axis;

FIG. 6 is a perspective view showing an example in which the shift lever and the linkage included in the transmission control device of FIG. 2 rotate about the third rotational axis;

FIG. 7 is a perspective view showing an example in which the shift lever and the linkage included in the transmission control device of FIG. 2 rotate about the first to the third rotational axes;

FIG. 8 is a cross sectional view taken along line B-B′ of the transmission control device of FIG. 4;

FIG. 9 is a cross sectional view taken along line D-D′ of the transmission control device of FIG. 5;

FIG. 10 is a cross sectional view taken along line C-C′ of the transmission control device of FIG. 4;

FIG. 11 is a cross sectional view taken along line E-E′ of the transmission control device of FIG. 6; and

FIG. 12 is a block diagram showing a vehicle according to the embodiments of the present invention.

### DETAILED DESCRIPTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

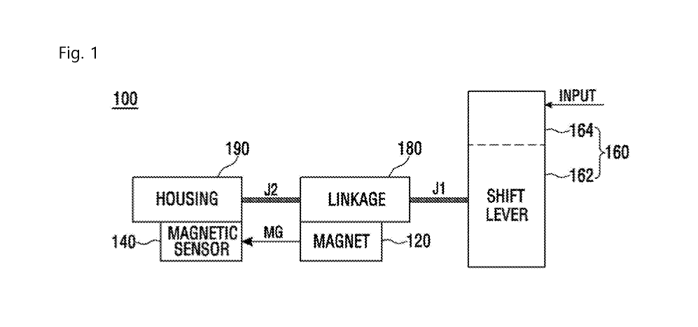

FIG. 1 is a block diagram showing a transmission control device according to embodiments of the present invention.

Referring to FIG. 1, a transmission control device 100 may include a magnet 120, a magnetic sensor 140, a shift lever 160, and a linkage 180.

The magnet 120 may generate a magnetic field (MG). In an embodiment, the magnet 120 may be a permanent magnet. In another embodiment, the magnet 120 may be an electromagnet. In this case, the strength of the magnetic field (MG) generated by the magnet 120 may be controlled by the magnitude of current supplied to the magnet 120. The magnet 120 may be disposed on the other end of the linkage 180. For example, the magnet 120 may be disposed in a space formed within the other end of the linkage 180.

The magnetic sensor 140 may measure the magnetic field (MG) which is changed according to a relative position with respect to the magnet 120. The farther it is from the magnet 120, the less the magnetic field (MG) generated around the magnet 120 is. Accordingly, a value of the measured strength of the magnetic field may be substantially changed according to a position where the magnetic sensor 140 measures the magnetic field (MG) in spite of the fact that the magnet 120 generates substantially the same magnetic field (MG). For example, a first measured value measured by the magnetic sensor 140 which measures the strength of the magnetic field (MG) at a position apart from the magnet 120 by a first distance may be relatively greater than a second measured value measured by the magnetic sensor 140 which measures the strength of the magnetic field (MG) at a position apart from the magnet 120 by a second distance relatively greater than the first distance. Through this, the distance between the magnet 120 and the magnetic sensor 140 can be estimated on the basis of the strength of the magnetic field (MG) measured by the magnetic sensor 140.

The magnetic sensor 140 may be a Hall integrated circuit (Hall IC). The Hall integrated circuit may be disposed in a housing 190 and may measure the strength of the magnetic field (MG) on the basis of a Hall effect.

The shift lever 160 may include a lever body 162 and a knob 164. The lever body 162 may be formed in a predetermined longitudinal direction, and the knob 164 may be disposed on one end of the lever body 162. Here, the knob 164 may receive a shift level from a user.

The lever body 162 may rotate about a center of rotation. For instance, the lever body 162 may rotate in space about one internal point as the center of rotation. Therefore, the knob 164 disposed on one end of the lever body 162 may move along the surface of a sphere centered on the center of rotation. In an embodiment, the center of rotation may be disposed on the other end of the lever body 162. In another embodiment, the center of rotation may be disposed in the middle of the lever body 162. For example, the center of rotation may be disposed at a position spaced apart from the knob 164 by a predetermined distance in the longitudinal direction.

The rotation of the lever body 162 may be restricted. The surface of the sphere on which the knob 164 can move may be limited to a portion of the entire surface of the sphere. For example, the knob 164 may move only along a preset surface that includes a predetermined surface corresponding to the shift level of the surface of the sphere. Here, the direction in which the knob 164 moves may be a longitudinal direction (shift direction) or a transverse direction (select direction).

The knob 164 may move along a third surface corresponding to a neutral level while moving from a first surface corresponding to a first shift level to a second surface corresponding to a second shift level. For example, the user may move the knob 164 located on the first surface corresponding to the first shift level by a predetermined distance in the shift direction, by a predetermined distance in the select direction, and again by a predetermined distance in the shift direction. As a result, the knob 164 may be located on the second surface corresponding to the second shift level. In addition, the knob 164 may move along the third surface while moving in the select direction.

The linkage 180, together with the lever body 162, may form a first joint structure J1 on one end, and the linkage 180, together with the housing 190, may form a second joint structure J2 on the other end. Since the knob 164 is located on one end of the lever body 162, the lever body 162 can be moved by the movement of the knob 164, and even the linkage 180 which forms, together with the lever body 162, the first joint structure J1 can be moved. However, since the magnetic sensor 140 is fixed at a predetermined position, the magnetic sensor 140 may not move by the movement of the linkage 180. That is, the center of rotation of the first joint structure J1 may move in space and the center of rotation of the second joint structure J2 may be fixed at a predetermined position. For example, the center of rotation of the first joint structure J1 may be a rotational axis moving in space, and the center of rotation of the second joint structure J2 may be a center point of rotation, which is fixed at a predetermined position.

Each of the first joint structure J1 and the second joint structure J2 may be any one of a hinge joint structure, a saddle joint structure, a ball-socket joint structure, and a pivot joint structure. Here, each of the first joint structure J1 and the second joint structure J2 may include a rotor relatively free to move and a fixing hole surrounding the rotor.

The first joint structure J1 may be a hinge joint structure including a first rotor and a first fixing hole surrounding the first rotor. Here, the first rotor included in the first joint structure J1 may rotate only about a rotational axis. The cross section of the first rotor obtained by cutting the first rotor in a direction substantially orthogonal to the rotational axis may be circular. However, the cross section of the first rotor obtained by cutting the first rotor in a direction not substantially orthogonal to the rotational axis may not be circular.

In particular, the cross section of the first rotor and/or the first fixing hole may have a cross-sectional shape formed such that the first rotor does not rotate about another rotational axis other than the rotational axis. For example, a particular cross section of the first rotor and/or the first fixing hole may have a protruding shape. Due to the protruding shape, the first rotor may not be able to rotate about a rotational axis that is substantially orthogonal to the cross-section.

Furthermore, the first joint structure J1 further includes an axial member formed in a direction substantially parallel to the rotational axis, so that the rotational axis of the first rotor can be fixed such that the first rotor can rotate only about the rotational axis.

Also, the second joint structure J2 may be a ball-socket joint structure including a second rotor and a second fixing hole. Here, the second rotor may be spherical or elliptical, and the second fixing hole corresponding to the second rotor may have a shape surrounding the spherical shape or elliptical shape. Also, the first fixing hole and/or the second fixing hole may have a depth sufficient to receive the linkage 180 at the neutral level.

The first joint structure J1 may be disposed at a position spaced apart from the knob 164 by a predetermined distance in the longitudinal direction of the lever body 162. That is, the lever body 162 and the linkage 180 may form the first joint structure J1 at a position spaced apart from the knob 164 in the longitudinal direction of the lever body 162 by a predetermined distance.

In the embodiment, the first rotor may be formed on one end of the linkage 180, and the lever body 162 may have the first fixing hole surrounding the first rotor. In this case, the first fixing hole may be formed in a spherical lever ball included in the lever body 162. The shift lever 160 may rotate about the center of the lever ball as the center of rotation. The lever ball may be integrally formed with the lever body 162, and may be separately formed and be coupled to the lever body 162. For example, the lever body 162 may be coupled to the lever ball by passing through the lever ball.

In another embodiment, the first rotor may be formed on the lever body 162, and the first fixing hole surrounding the first rotor may be formed in one end of the linkage 180. In this case, the first rotor may be formed on the spherical lever ball included in the lever body 162.

The linkage 180 and the housing 190 may form the second joint structure J2. In other words, the linkage 180, together with the housing 190, may form the second joint structure J2.

In the embodiment, the second rotor may be formed on the other end of the linkage 180, and the housing 190 may have the second fixing hole surrounding the second rotor. In another embodiment, the second rotor may be formed in the housing 190, and the second fixing hole surrounding the second rotor may be formed on the other end of the linkage 180.

The shift lever 160 may rotate about a first rotational axis in a first direction. Here, the linkage 180 may rotate about a second rotational axis substantially parallel to the first rotational axis in a second direction reverse to the first direction. For example, when the knob 164 is moved in the shift direction by the user, the shift lever 160 may rotate in the clockwise direction about the first rotational axis, and thus, the linkage 180 may rotate in the counterclockwise direction about the second rotational axis substantially parallel to the first rotational axis.

The shift lever 160 may rotate in a third direction about a third rotational axis that is substantially orthogonal to the first rotational axis. Here, the linkage 180 may rotate about the third rotational axis in the third direction. For example, the user moves the knob 164 in the select direction, so that the shift lever 160 may rotate about the third rotational axis in the clockwise direction. Accordingly, the linkage 180 may also rotate about the third rotational axis in the clockwise direction.

The Hall integrated circuit disposed in the housing 190 may measure, on the basis of the Hall effect, the magnetic field (MG) generated by the magnet 120 disposed on the other end of the linkage 180. The position of the magnet 120 may be changed by the movement of the linkage 180, while the Hall integrated circuit maintains a relatively fixed position. Therefore, when the shift lever 160 is moved by the user's input, the linkage 180 and the magnet 120 disposed on the other end of the linkage 180 may be moved together by the first joint structure J1. As a result, the strength of the magnetic field (MG) measured by the Hall integrated circuit included in the magnetic sensor 140 may be changed. Based on the thus measured strength of the magnetic field (MG), the current position of the shift lever 160, that is, the current shift level, can be estimated.

Further, an idle stop & go (ISG) function may be performed based on the magnetic field (MG) measured later. For example, an electronic control unit (ECU) included in a vehicle is able to drive the Idle Stop & Go (ISG) function according to the strength of the magnetic field (MG) measured in the neutral level where the power of the engine is not transmitted to the wheels.

The transmission control device 100 according to the embodiments of the present invention may detect that the shift level change on the basis of the magnetic field (MG) that changes in accordance with the movement of the linkage 180 forming the first joint structure J1 and the second joint structure J2. The linkage 180 in which the magnet 120 is disposed forms the first joint structure J1 and the second joint structure J2, a range in which the magnet 120 moves in space may be reduced compared to a case where there is no joint structure. Furthermore, the first joint structure J1 may be formed in the middle of the lever body 162 as well. As a result, the transmission control device 100 that detects the shift level change can be implemented even in a narrow space.

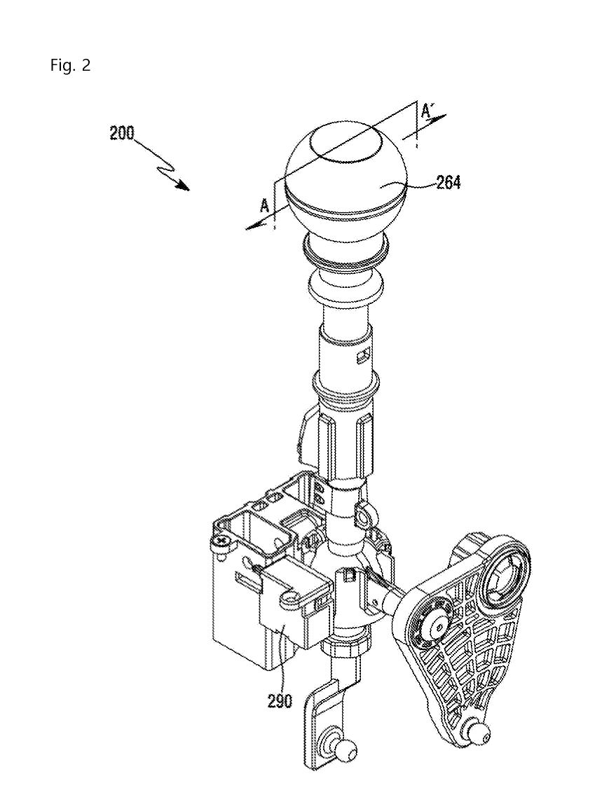

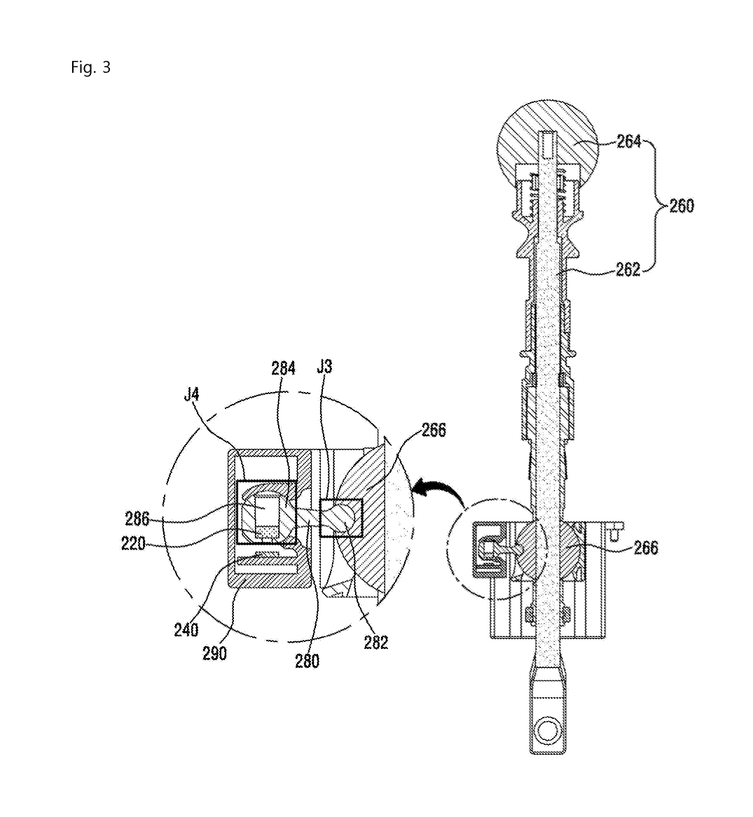

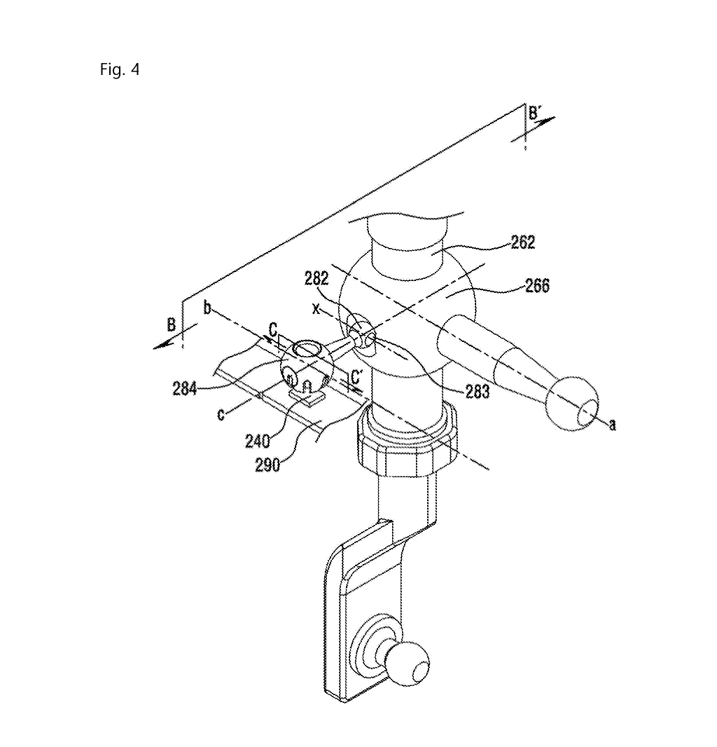

FIG. 2 is a perspective view showing an example of the transmission control device of FIG. 1. FIG. 3 is a cross sectional view taken along line A-A′ of the transmission control device of FIG. 2. FIG. 4 is a perspective view showing examples of the first to the third rotational axes about which the shift lever and the linkage which are included in the transmission control device of FIG. 2 rotate.

Referring to FIGS. 2 to 4, a transmission control device 200 may include a magnet 220, a magnetic sensor 240, a shift lever 260, and a linkage 280.

The magnet 220 may generate a magnetic field. In an embodiment, the magnet 220 may be a permanent magnet. In another embodiment, the magnet 220 may be an electromagnet. The magnet 220 may be disposed in a space 286 formed within the other end of the linkage 280.

The magnetic sensor 240 may measure the magnetic field which is changed according to a relative position with respect to the magnet 220. The farther it is from the magnet 220, the less the magnetic field generated around the magnet 220 is. Accordingly, a value of the measured strength of the magnetic field may be substantially changed according to a position where the magnetic sensor 240 measures the magnetic field in spite of the fact that the magnet 220 generates substantially the same magnetic field. Through this, the distance between the magnet 220 and the magnetic sensor 240 can be estimated on the basis of the strength of the magnetic field measured by the magnetic sensor 240.

The magnetic sensor 240 may be the Hall integrated circuit. The Hall integrated circuit may be disposed in a housing 290 and may measure the strength of the magnetic field on the basis of the Hall effect.

The shift lever 260 may include a lever body 262 and a knob 264. The lever body 262 may be formed in a predetermined longitudinal direction, and the knob 264 may be disposed on one end of the lever body 262. Here, the knob 264 may receive the shift level from the user.

The lever body 262 may include a lever ball 266 including a center of rotation. For example, the lever body 262 may rotate in space about the center of the lever ball 266 as the center of rotation. Therefore, the knob 264 disposed on one end of the lever body 262 may move along the surface of a sphere centered on the lever ball 266. The lever ball 266 may be disposed in the middle of the lever body 262.

The rotation of the lever body 262 may be restricted. The surface of the sphere on which the knob 264 can move may be limited to a portion of the entire surface of the sphere. For example, the knob 264 may move only along a preset surface that includes a predetermined surface corresponding to the shift level of the surface of the sphere. Here, the direction in which the knob 264 moves may be a longitudinal direction (shift direction) or a transverse direction (select direction).

The knob 264 may move along the third surface corresponding to the neutral level while moving from the first surface corresponding to the first shift level to the second surface corresponding to the second shift level. For example, the user may move the knob 264 located on the first surface corresponding to the first shift level by a predetermined distance in the shift direction, by a predetermined distance in the select direction, and again by a predetermined distance in the shift direction. As a result, the knob 264 may be located on the second surface corresponding to the second shift level. In addition, the knob 264 may move along the third surface while moving in the select direction.

The linkage 280, together with the lever body 262, may form a first joint structure J3 on one end, and the linkage 280, together with the housing 290, may form a second joint structure J4 on the other end. Since the knob 264 is located on one end of the lever body 262, the lever body 262 can be moved by the movement of the knob 264, and even the linkage 280 which forms, together with the lever body 262, the first joint structure J3 can be moved. However, since the magnetic sensor 240 is fixed at a predetermined position, the magnetic sensor 240 may not move by the movement of the linkage 280. That is, the center of rotation of the first joint structure J3 may move in space and the center of rotation of the second joint structure J4 may be fixed at a predetermined position.

The first joint structure J3 may be a hinge joint structure, and the second joint structure J4 may be a ball-socket joint structure. Here, each of the first joint structure J3 and the second joint structure J4 may include the rotor relatively free to move and the fixing hole surrounding the rotor.

The first joint structure J3 may be a hinge joint structure including the first rotor 282 and the first fixing hole surrounding the first rotor 282. Here, the first rotor 282 included in the first joint structure J3 may rotate only about a rotational axis “x”. The cross section of the first rotor 282 obtained by cutting the first rotor 282 in a direction substantially orthogonal to the rotational axis “x” may be circular. However, the cross section of the first rotor 282 obtained by cutting the first rotor 282 in a direction not substantially orthogonal to the rotational axis “x” may not be circular.

In particular, the cross section of the first rotor 282 and the first fixing hole may have a cross-sectional shape formed such that the first rotor 282 does not rotate around a rotational axis other than the rotational axis “x”. For example, the first rotor 282 may have a cut plane 283 obtained by cutting the first rotor 282 in a direction substantially orthogonal to the rotational axis “x”, and the first fixing hole may have a shape surrounding this cut plane 283. Here, the cross section of the first fixing hole obtained by cutting the first fixing hole in the direction substantially orthogonal to the third rotational axis “c” may have a shape protruding toward the first rotor 282. Due to the protruding shape, the first rotor 282 may not be able to rotate about the third rotational axis “c”.

The second rotor 284 included in the second joint structure J4 may be spherical or elliptical, and the second fixing hole corresponding to the second rotor 284 may have a shape surrounding the spherical shape or elliptical shape. Also, the first fixing hole and/or the second fixing hole may have a depth sufficient to receive the linkage 280 at the neutral level.

The first joint structure J3 may be disposed at a position spaced apart from the knob 264 by a predetermined distance in the longitudinal direction of the lever body 262. That is, the lever body 262 and the linkage 280 may form the first joint structure J3 at a position spaced apart from the knob 264 in the longitudinal direction of the lever body 262 by a predetermined distance.

The first rotor 282 may be formed on one end of the linkage 280, and the lever body 262 may have the first fixing hole surrounding the first rotor 282. In this case, the first fixing hole may be formed in the spherical lever ball 266 included in the lever body 262. The shift lever 260 may rotate about the center of the lever ball 266 as the center of rotation. The lever ball 266 may be separately formed and be coupled to the lever body 262. For example, the lever body 262 may be coupled to the lever ball 266 by passing through the lever ball 266.

The linkage 280 and the housing 290 may form the second joint structure J4. In other words, the linkage 280, together with the housing 290, may form the second joint structure J4. The second rotor 284 may be formed on the other end of the linkage 280, and the housing 290 may have the second fixing hole surrounding the second rotor 284.

The shift lever 260 may rotate about the first rotational axis “a” in the first direction. Here, the linkage 280 may rotate about the second rotational axis “b” substantially parallel to the first rotational axis “a” in the second direction reverse to the first direction.

The shift lever 260 may rotate in the third direction about the third rotational axis “c” that is substantially orthogonal to the first rotational axis “a”. Here, the linkage 280 may rotate about the third rotational axis “c” in the third direction.

The magnetic sensor 240 disposed within the housing 290 may be the Hall integrated circuit. The Hall integrated circuit may measure, on the basis of the Hall effect, the magnetic field generated by the magnet 220 disposed on the other end of the linkage 280. The position of the magnet 220 may be changed by the movement of the linkage 280, while the magnetic sensor 240 maintains a relatively fixed position. Therefore, when the shift lever 260 is moved by the user's input, the linkage 280 and the magnet 220 disposed on the other end of the linkage 280 may be moved together by the first joint structure J3. As a result, the strength of the magnetic field measured by the magnetic sensor 240 may be changed. Based on the thus measured strength of the magnetic field, the current position of the shift lever 260, that is, the current shift level, can be estimated.

Further, the idle stop & go (ISG) function may be performed based on the magnetic field measured later. For example, the electronic control unit included in a vehicle is able to drive the Idle Stop & Go (ISG) function according to the strength of the magnetic field measured at the neutral level where the power of the engine is not transmitted to the wheels.

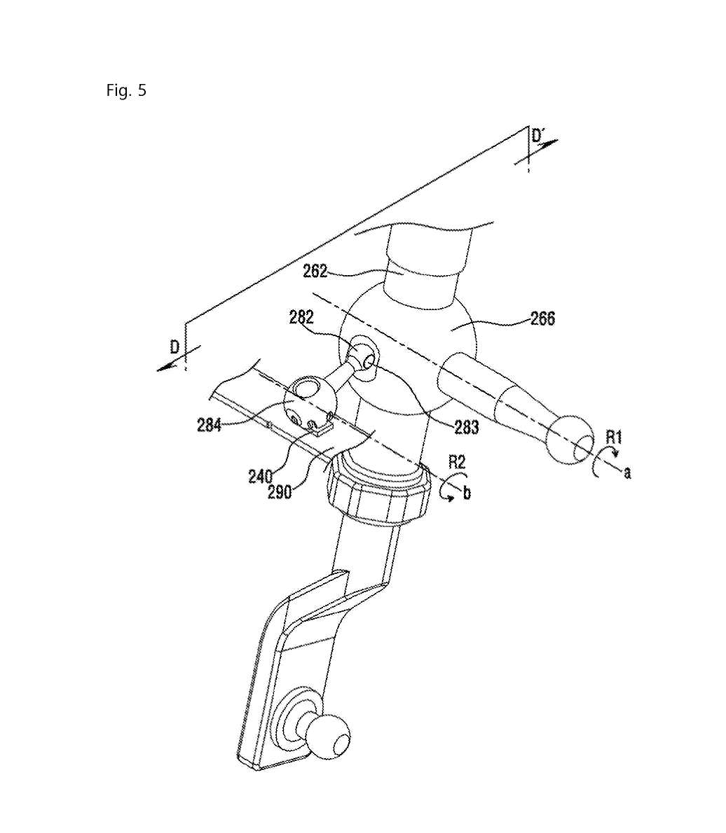

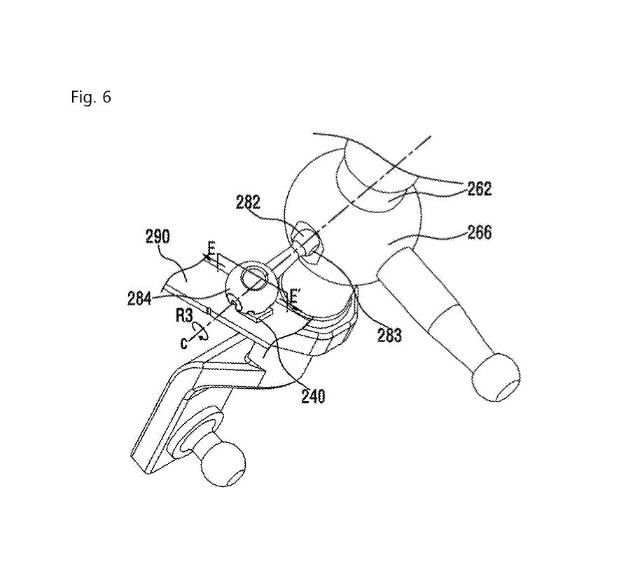

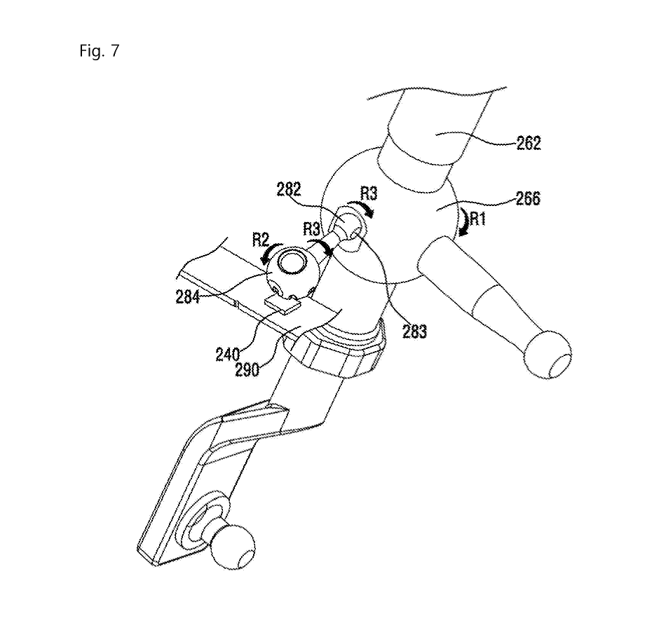

FIG. 5 is a perspective view showing an example in which the shift lever and the linkage included in the transmission control device of FIG. 2 rotate about the first rotational axis and the second rotational axis. FIG. 6 is a perspective view showing an example in which the shift lever and the linkage included in the transmission control device of FIG. 2 rotate about the third rotational axis. FIG. 7 is a perspective view showing an example in which the shift lever and the linkage included in the transmission control device of FIG. 2 rotate about the first to the third rotational axes.

Referring to FIG. 5, the shift lever 260 may rotate about the first rotational axis “a” in the first direction. Here, the linkage 280 may rotate about the second rotational axis “b” substantially parallel to the first rotational axis “a” in the second direction reverse to the first direction.

For example, when the knob 264 is moved in the shift direction by the user, the shift lever 260 and the lever ball 266 included in the shift lever 260 may rotate in the clockwise direction R1 about the first rotational axis “a”, and thus, the linkage 280 may rotate in the counterclockwise direction R2 about the second rotational axis “b” substantially parallel to the first rotational axis “a”.

Referring to FIG. 6, the shift lever 260 may rotate in the third direction about the third rotational axis “c” that is substantially orthogonal to the first rotational axis “a”. Here, the linkage 280 may rotate about the third rotational axis “c” in the third direction.

For example, the user moves the knob 264 in the select direction, so that the shift lever 260 and the lever ball 266 included in the shift lever 260 may rotate about the third rotational axis “c” in the clockwise direction R3. Accordingly, the linkage 280 may also rotate about the third rotational axis “c” in the clockwise direction R3.

Referring to FIG. 7, the shift lever 260 may rotate about the first rotational axis “a” in the first direction and about the third rotational axis “c” in the third direction. Here, the linkage 280 may rotate about the second rotational axis “b” in the second direction and may rotate about the third rotational axis “c” in the third direction.

For example, when the knob 264 is moved in the shift direction and in the select direction by the user, the shift lever 260 and the lever ball 266 included in the shift lever 260 may rotate about the first rotational axis “a” in the clockwise direction R1 and may rotate about the third rotational axis “c” in the clockwise direction R3. Accordingly, the linkage 280 may rotate about the second rotational axis “b” in the counterclockwise direction R2 and may rotate about the third rotational axis “c” in the clockwise direction R3.

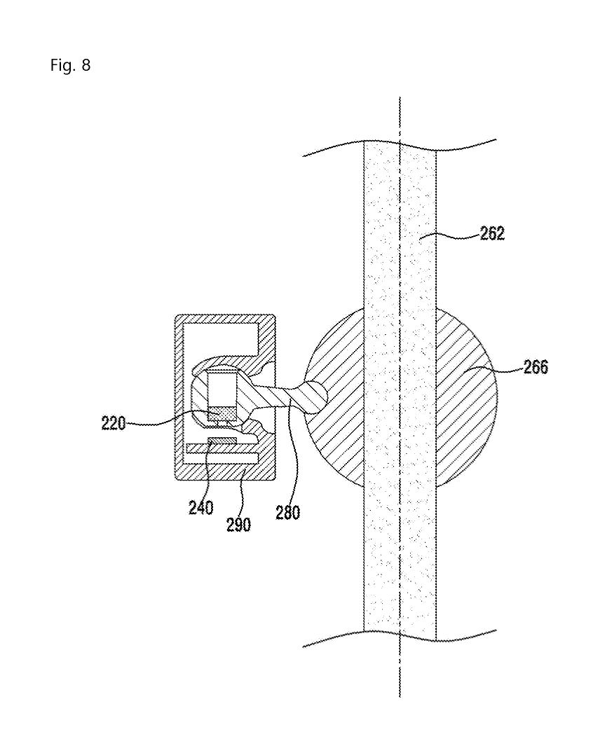

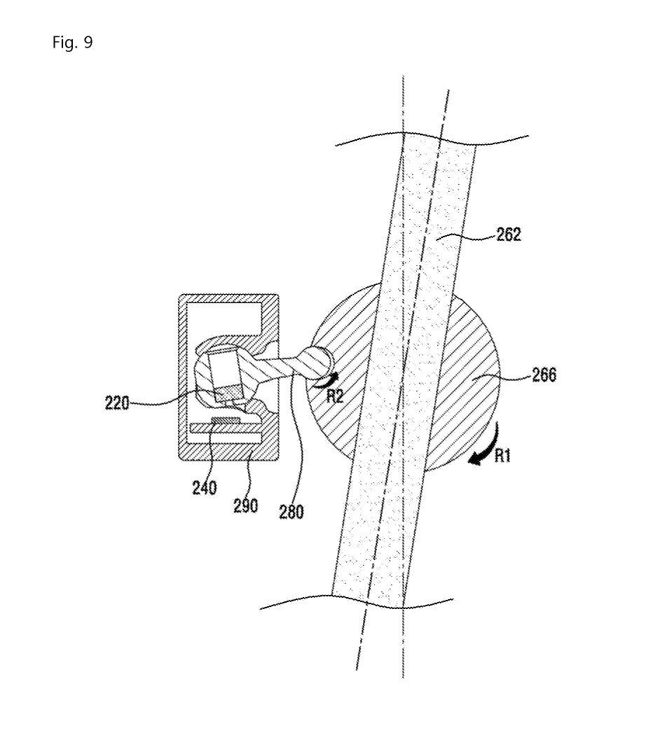

FIG. 8 is a cross sectional view taken along line B-B′ of the transmission control device of FIG. 4. FIG. 9 is a cross sectional view taken along line D-D′ of the transmission control device of FIG. 5.

Referring to FIG. 8, the magnetic sensor 240 may measure the strength of the magnetic field at a position apart from the magnet 220 by the first distance and obtain the first measured value. For example, the distance between the magnet 220 and the magnetic sensor 240 (i.e., the first distance) at the neutral level may have a minimum value. Accordingly, the first measured value measured by the magnetic sensor 240 may be the maximum value of the values measured by the magnetic sensor 240.

Referring to FIG. 9, the magnetic sensor 240 may measure the strength of the magnetic field at a position apart from the magnet 220 by the second distance and obtain the second measured value. Here, the second measured value may be relatively less than the first measured value.

At a non-neutral level, the lever ball 266 may rotate in the clockwise direction R1 at a first angle, and the first fixing hole may also move along a circle centered on the center of rotation at the first angle. Accordingly, the first joint structure J1 enables the linkage 280 to rotate in the counterclockwise direction R2 at a second angle. The rotation of the linkage 280 also enables the magnet 220 disposed on the other end of the linkage 280 to rotate at the second angle. Here, since the distance between the magnet 220 and the magnetic sensor 240 (i.e., the second distance) is relatively greater than the first distance, the second measured value may be relatively less than the first measured value.

Therefore, whether the shift level is the neutral level or not and the moving distance in the shift direction can be detected based on when the magnetic sensor 240 detects the maximum value.

Referring back to FIGS. 8 and 9, the first fixing hole and the second fixing hole may have a depth sufficient to receive the linkage 280 at the neutral level. The linkage 280 may not be an elastic body. Therefore, the length of the linkage 280 may be relatively greater than the shortest distance between the first joint structure J3 and the second joint structure J4. As a result, even at the non-neutral level, the linkage 280 may be located between the first joint structure J3 and the second joint structure J4.

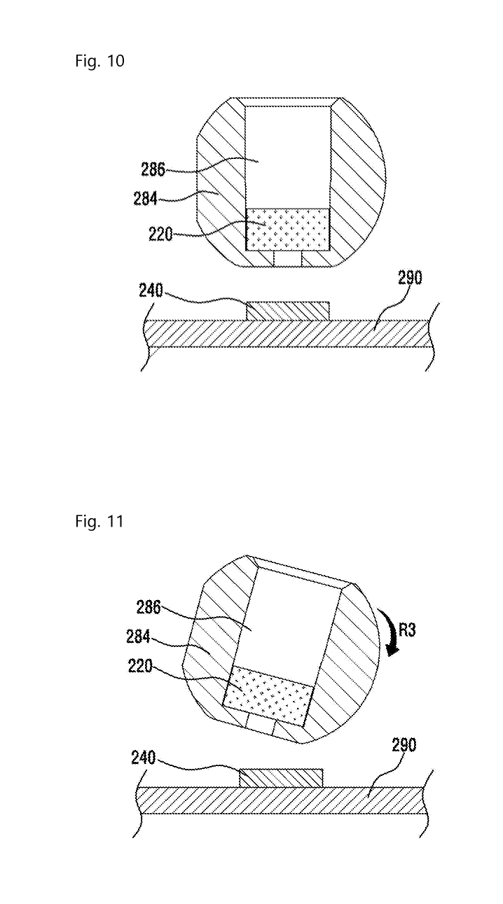

FIG. 10 is a cross sectional view taken along line C-C′ of the transmission control device of FIG. 4. FIG. 11 is a cross sectional view taken along line E-E′ of the transmission control device of FIG. 6.

Referring to FIG. 10, the magnetic sensor 240 may measure the strength of the magnetic field at a position apart from the magnet 220 by a third distance and obtain a third measured value. For example, the distance between the magnet 220 and the magnetic sensor 240 (i.e., the third distance) at the state where knob 264 is not moved in the select direction may have a minimum value. Accordingly, the third measured value measured by the magnetic sensor 240 may be the maximum value of the values measured by the magnetic sensor 240.

Referring to FIG. 11, the magnetic sensor 240 may measure the strength of the magnetic field at a position apart from the magnet 220 by a fourth distance and obtain a fourth measured value. Here, the fourth measured value may be relatively less than the third measured value.

In the state where the knob 264 has been moved in the select direction, the lever ball 266 may rotate in the clockwise direction R3 at a third angle, and the linkage 280 and the second rotor 284 included in the linkage 280 may also rotate in the clockwise direction R3 at the third angle. As a result, the magnet 220 disposed on the second rotor 284 may rotate at the third angle. Here, since the distance between the magnet 220 and the magnetic sensor 240 (i.e., the fourth distance) is relatively greater than the third distance, the fourth measured value may be relatively less than the third measured value.

Therefore, the moving distance in the select direction can be detected based on when the magnetic sensor 240 detects the maximum value.

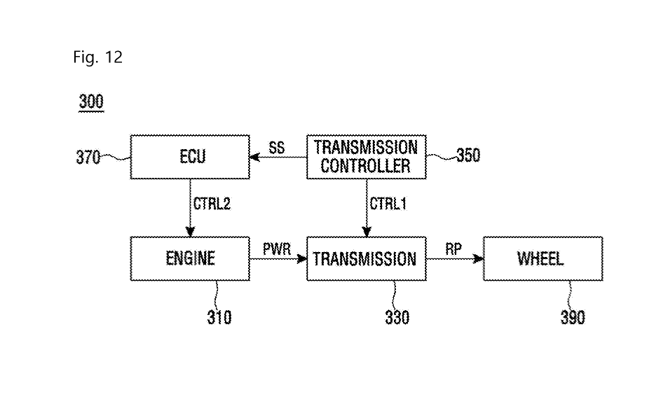

FIG. 12 is a block diagram showing a vehicle according to the embodiments of the present invention.

Referring to FIG. 12, a vehicle 300 may include an engine 310, a transmission 330, and a transmission control device 350. According to the embodiment, the vehicle 300 may further include an electronic control unit 370 and/or a wheel 390.

The engine 310 may generate power PWR. The generated power PWR may be transmitted to the transmission 330. The transmission 330 is able to convert the power PWR into a rotational force RP. For this purpose, the transmission 330 may use different gears according to the shift level. The generated rotational force RP may be transmitted to the wheel 390.

The transmission control device 350 can control the transmission 330 by controlling the shift level. For example, the transmission control device 350 can control the transmission 330 by a first control method CTRL1 that mechanically and/or electrically performs a control.

The transmission control device 350 may include the magnet, the magnetic sensor, the shift lever, and the linkage. The magnetic sensor may measure the magnetic field which is changed according to the relative position with respect to the magnet. The shift lever may include the lever body and the knob. Here, the knob may be disposed on one end of the lever body and may receive a shift level from the user. The linkage, together with the lever body, may form the first joint structure on one end, and the linkage, together with the housing, may form the second joint structure on the other end. Here, the magnet may be disposed on the other end of the linkage.

The electronic control unit 370 may drive the idle stop & go (ISG) function on the basis of the measured magnetic field SS. To this end, the electronic control unit 370 can control the starting of the engine by a second control method CTRL2 that mechanically and/or electrically controls the engine 310. For example, the electronic control unit 370 may drive the idle stop & go (ISG) function on the basis of the magnetic field SS measured at the neutral level in which the power PWR of the engine 310 is not finally transmitted to the wheel 390. That is, the electronic control unit 370 can turn off the engine 310 at the neutral level.

The wheel 390 may move the vehicle 300 forward or backward by a frictional force with the ground according to the rotational force RP.

The vehicle 300 according to the embodiments of the present invention includes the transmission control device 350, thereby detecting the neutral level that is an intermediate state during the change of the shift level and thereby implementing the idle stop & go (ISG) function.

While the transmission control device according to the embodiments of the present invention and the vehicle including the same have been described, the foregoing embodiments are merely exemplary and may be changed or modified without departing from the technical spirit of the present invention by a person having ordinary skill in the art to which the present invention pertains to.

The present invention can be variously applied to a vehicle equipped with a manual transmission control device. For example, the present invention can be applied to a passenger car, a van, a truck, a bus, a construction equipment, and the like having a manual transmission control device.

While the present invention has been described with reference to the embodiments thereof, it will be understood by those skilled in the art that various changes and modification in forms and details may be made without departing from the spirit and scope of the present invention as defined by the appended claims.

What is claimed is:

1. A transmission control device comprising:
a magnet;
a magnetic sensor which measures a magnetic field which is changed according to a relative position with respect to the magnet;
a housing in which the magnetic sensor is disposed;
a shift lever which comprises a lever body and a knob which is disposed on one end of the lever body and receives a shift level from a user; and
a linkage which, together with the lever body, forms a first joint structure on one end and which, together with the housing, forms a second joint structure on the other end on which the magnet is disposed.

2. The transmission control device of claim 1, wherein a center of rotation of the first joint structure moves in space, and wherein a center of rotation of the second joint structure is fixed at a predetermined position.

3. The transmission control device of claim 1, wherein the first joint structure is a hinge joint structure.

4. The transmission control device of claim 3, wherein a first rotor is formed on one end of the linkage, and wherein the lever body has a first fixing hole surrounding the first rotor.

5. The transmission control device of claim 4, wherein the lever body comprises a spherical lever ball in which the first fixing hole is formed, and wherein the shift lever rotates about the center of the lever ball as a center of rotation.

6. The transmission control device of claim 3, wherein, when the shift lever rotates about a first rotational axis in a first direction, the linkage rotates about a second rotational axis parallel to the first rotational axis in a second direction reverse to the first direction.

7. The transmission control device of claim 6, wherein, when the shift lever rotates in a third direction about a third rotational axis that is orthogonal to the first rotational axis, the linkage rotates about the third rotational axis in the third direction.

8. The transmission control device of claim 1, wherein the second joint structure is a ball-socket joint structure.

9. The transmission control device of claim 8, wherein a second rotor is formed on the other end of the linkage, wherein the housing has a second fixing hole surrounding the second rotor, and wherein the magnetic sensor is a Hall integrated circuit (Hall IC).

10. A vehicle comprising:
an engine which generates power;
a transmission which use different gears according to a shift level and converts the power into a rotational force; and
a transmission control device which controls the shift level,
wherein the transmission control device comprises:
a magnet;
a magnetic sensor which measures a magnetic field which is changed according to a relative position with respect to the magnet;
a housing in which the magnetic sensor is disposed;
a shift lever which comprises a lever body and a knob which is disposed on one end of the lever body and receives the shift level from a user; and
a linkage which, together with the lever body, forms a first joint structure on one end and which, together with the housing, forms a second joint structure on the other end on which the magnet is disposed.

11. The vehicle of claim 10, further comprising an electronic control unit (ECU) which drives an idle stop & go (ISG) function on the basis of the magnetic field measured at a neutral level where the power of the engine is not transmitted to wheels.
